(19) United States
(12) Patent Application Publication
(10) Pub. No.: US 2025/0201436 A1
(43) Pub. Date: Jun. 19, 2025

(54) METHODS AND APPARATUSES FOR ALIGNMENT OF ION CHAIN TO DETECTOR ARRAY BY SHELVING

(71) Applicant: IonQ, Inc., Collage Park, MD (US)

(72) Inventor: Michael Lurie GOLDMAN, University Park, MD (US)

(21) Appl. No.: 18/986,444

(22) Filed: Dec. 18, 2024

Related U.S. Application Data
(60) Provisional application No. 63/611,613, filed on Dec. 18, 2023.

(51) Int. Cl. G21K 1/00; G01N 15/1433; G01N 15/1434; G06N 10/40

(52) U.S. Cl. CPC G21K 1/003; G01N 15/1433; G01N 15/1434; G06N 10/40

(57) ABSTRACT

Aspects of the present disclosure may include methods and systems for applying a first plurality of light beams to transition the plurality of ions to a bright state, detecting first positions of the plurality of ions using the plurality of photodetectors, applying a second plurality of light beams to shelve a first subset of the plurality of ions to a metastable dark state, capturing at least one image of the plurality of ions after the applying of the second plurality of light beams, determining second positions of the plurality of ions based on the at least one image, and aligning a second subset of the plurality of ions to the plurality of photodetectors based on the second positions.

### CROSS-REFERENCE TO RELATED APPLICATIONS

The current application claims priority to, and the benefit of, U.S. Provisional Application No. 63/611,613 filed on Dec. 18, 2023 and entitled “METHODS AND APPARATUSES FOR ALIGNMENT OF ION CHAIN TO DETECTOR ARRAY BY SHELVING,” the contents of which are hereby incorporated by reference in their entireties.

### BACKGROUND

In a quantum information processing (QIP) system, the entanglement of trapped ions in an ion chain is used for performing logic and/or computation. The quantum states of the trapped ions represent the computational states of the logic. Therefore, it may be important to monitor the quantum states of the trapped ions. One method is to use photodetectors, such as photo-multiplier, photon counters, and/or avalanche photodiodes. It is important to properly align the photodetectors to the corresponding trapped ion. However, there may be difficulties during the alignment process. Therefore, improvements in the alignment process may be desirable.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure may include methods and systems for applying a first plurality of light beams to transition the plurality of ions to a bright state, detecting first positions of the plurality of ions using the plurality of photodetectors, applying a second plurality of light beams to shelve a first subset of the plurality of ions to a metastable dark state, capturing at least one image of the plurality of ions after the applying of the second plurality of light beams, determining second positions of the plurality of ions based on the at least one image, and aligning a second subset of the plurality of ions to the plurality of photodetectors based on the second positions.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates examples of detection results and image capturing results in accordance with aspects of this disclosure.

FIG. 5 illustrates an example of a method for aligning one or more photodetectors to an ion chain according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

In an aspect, the state of the qubits in a QIP system may be read out by detecting state-dependent fluorescence from the ions. This may require making a quick measurement of the fluorescence from all ions in the quantum register in parallel. One method of performing this measurement is by imaging the ion chain onto an array of photon detectors such that one detector counts the photons emitted from one ion. This can be done by imaging the ions onto a multi-core fiber array and then routing the individual fibers to individual photon counters, which can be photo-multiplier tubes (PMTs), avalanche photodiodes (APDs), or a similar technology. One could also dispense with the fiber array and image the chain directly onto the detector array of one multi-channel detector module.

One important task in the bring-up of a trapped ion-based quantum computer is aligning optics so that the ion chain, in its proper operating position and spacing, is imaged to the detector array with proper alignments of ions to detectors. There can be either more or fewer ions in the chain than there are detectors in the array, and we need not necessarily use all ions as qubits, which means that there may be some ions (likely on the ends of the chain) that do not need to be imaged to detectors.

When the ion chain is well-aligned to the detectors and there are fewer ions than detectors, it is easy to determine which ion is mapped to which detector by counting inward from the dark (i.e., registering few photons) detectors on the ends of the array. However, this approach may be undesirable if there are more ions than detectors. In that case, it may be necessary to move the imaging optics to move the image of the chain relative to the detector array. Once one end of the detector array goes dark, the end of the chain may be located. By moving the optics in the opposite direction by a known distance, the detector array may be aligned to the center of the chain with a known detector-ion mapping. However, it may be desirable to not move the imaging optics in this way, and this approach is complicated slightly by the fact that, even with a confining voltage potential that is carefully set to ensure equal spacing of the ions, the few ions at the ends of the chain often have different spacings than those in the center of the chain.

Moreover, these approaches work best when the optical alignment is already close to the correct position. In the initial stages of alignment, the magnification of the optical system may be substantially improperly set, so that the spacing of the image of the ion chain produced at the location of the detector array does not match the spacing of the detector array. Consequently, there may be an aliased pattern of bright and dark detectors, and it may be very difficult to disentangle the effects of the various types of misalignment (i.e., incorrect magnification vs position) and to determine how the optics need to be adjusted. This particularly applies in the case where there are more ions than detectors.

The above schemes of determining which ions are mapped to which detectors share a common weakness: they only extract information from the ends of the ion chain. They rely on observing the boundary between bright and dark detectors, which reveals where the last ion on one end of the chain is mapped. These methods therefore become more difficult to use when these boundaries fall beyond the ends of the detector array because there are more ions than detectors, or when an improperly set magnification leads to an aliasing pattern that produces periodic patterns of bright and dark detectors that can mask the clear boundaries that indicate the ends of the chain.

Aspects of the present disclosure include shelving selected trapped ions in an ion chain to the metastable states while the remaining trapped ions remain in the bright state. During the shelving process, the luminosity of the selected trapped ions may change. A camera may capture images of the ion chain, including the “dimmed” selected trapped ions that have been shelved to the metastable states. The captured images may be compared to the responses detected by the photodetectors. By matching the detected responses (e.g., ions with “low” photon counts) to the captured images (e.g., ions that appear dimmed), the ion chain may be properly aligned.

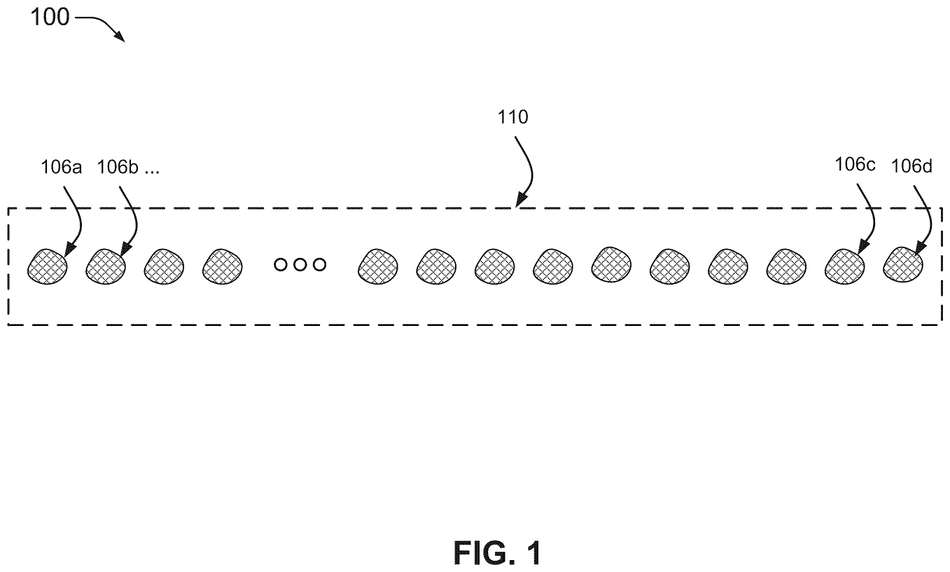

Example QIP systems that may implement aspects of the present disclosure are shown in FIGS. 1-3.

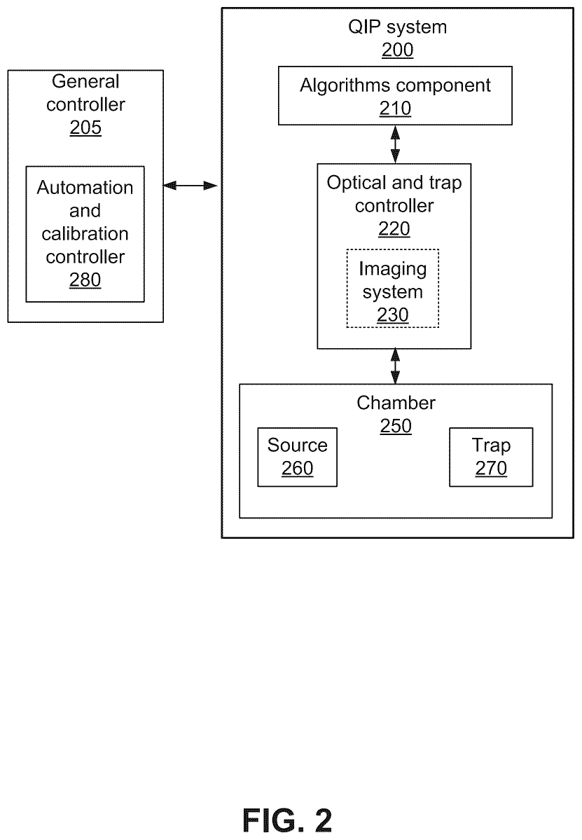

FIG. 1 shown below illustrates a diagram 100 with multiple atomic ions 106 (e.g., atomic ions 106a, 106b, . . . , 106c, and 106d) trapped in a linear crystal or chain 110 using a trap (the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The atomic ions 106 may be provided to the trap as atomic species for ionization and confinement into the chain 110.

In the example shown in FIG. 1, the trap includes electrodes for trapping or confining multiple atomic ions into the chain 110 that are laser-cooled to be nearly at rest. The number of atomic ions (N) trapped can be configurable and more or fewer atomic ions may be trapped. The atomic ions can be Ytterbium ions (e.g., 171Yb+ ions), for example. The atomic ions are illuminated with laser (optical) radiation tuned to a resonance in 171Yb+ and the fluorescence of the atomic ions is imaged onto a camera or some other type of detection device. In this example, atomic ions may be separated by about 5 microns (μm) from each other, although the separation may be smaller or larger than 5 μm. The separation of the atomic ions is determined by a balance between the external confinement force and Coulomb repulsion and does not need to be uniform. Moreover, in addition to atomic Ytterbium ions, neutral atoms, Rydberg atoms, different atomic ions or different species of atomic ions may also be used (such as one or more isotopes of barium, for example). The trap may be a linear RF Paul trap, but other types of confinement may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 shown below is a block diagram that illustrates an example of a QIP system 200 in accordance with various aspects of this disclosure.

The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations.

Shown in FIG. 2 is a general controller 205 configured to perform various control operations of the QIP system 200. Instructions for the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200.

The QIP system 200 may include an algorithms component 210 that may operate with other parts of the QIP system 200 to perform quantum algorithms or quantum operations, including a stack or sequence of combinations of single qubit operations and/or multi-qubit operations (e.g., two-qubit operations) as well as extended quantum computations. As such, the algorithms component 210 may provide instructions to various components of the QIP system 200 (e.g., to the optical and trap controller 220) to enable the implementation of the quantum algorithms or quantum operations. The algorithms component 210 may receive information resulting from the implementation of the quantum algorithms or quantum operations and may process the information and/or transfer the information to another component of the QIP system 200 or to another device for further processing.

The QIP system 200 may include an optical and trap controller 220 that controls various aspects of a trap 270 in a chamber 250, including the generation of signals to control the trap 270, and controls the operation of lasers and optical systems that provide optical beams that interact with the atoms or ions in the trap. When used to confine or trap ions, the trap 270 may be referred to as an ion trap. The trap 270, however, may also be used to trap neutral atoms, Rydberg atoms, different atomic ions or different species of atomic ions. The lasers and optical systems can be at least partially located in the optical and trap controller 220 and/or in the chamber 250. For example, optical systems within the chamber 250 may refer to optical components or optical assemblies.

The QIP system 200 may include an imaging system 230. The imaging system 230 may include a high-resolution imager (e.g., CCD camera) or other type of detection device (e.g., photomultiplier tube or PMT) for monitoring the atomic ions while they are being provided to the trap 270 and/or after they have been provided to the trap 270. In an aspect, the imaging system 230 can be implemented separate from the optical and trap controller 220, however, the use of fluorescence to detect, identify, and label atomic ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of a processor or processing portion of the QIP system 200. That is, the trap 270 may be considered at the core of the processing operations of the QIP system 200 since it holds the atomic-based qubits that are used to perform the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the general controller 205, the automation and calibration controller 280, the optical and trap controller 220, and/or the imaging system 230.

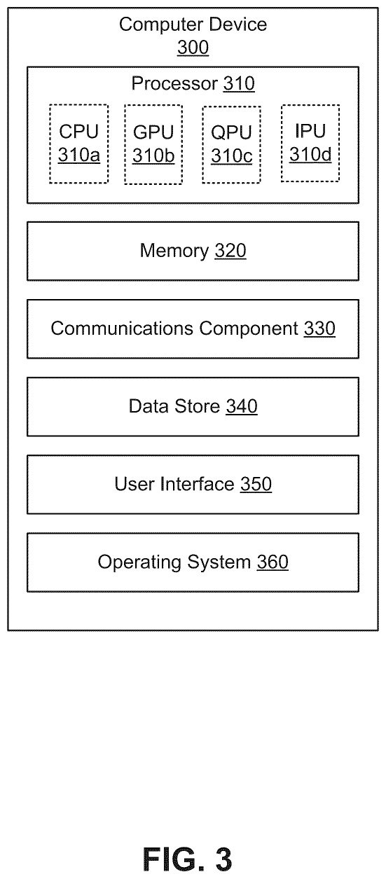

Referring now to FIG. 3 shown below, illustrated is an example of a computer system or device 300 in accordance with aspects of the disclosure. The computer device 300 can represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single or multiple set of processors or multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300).

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

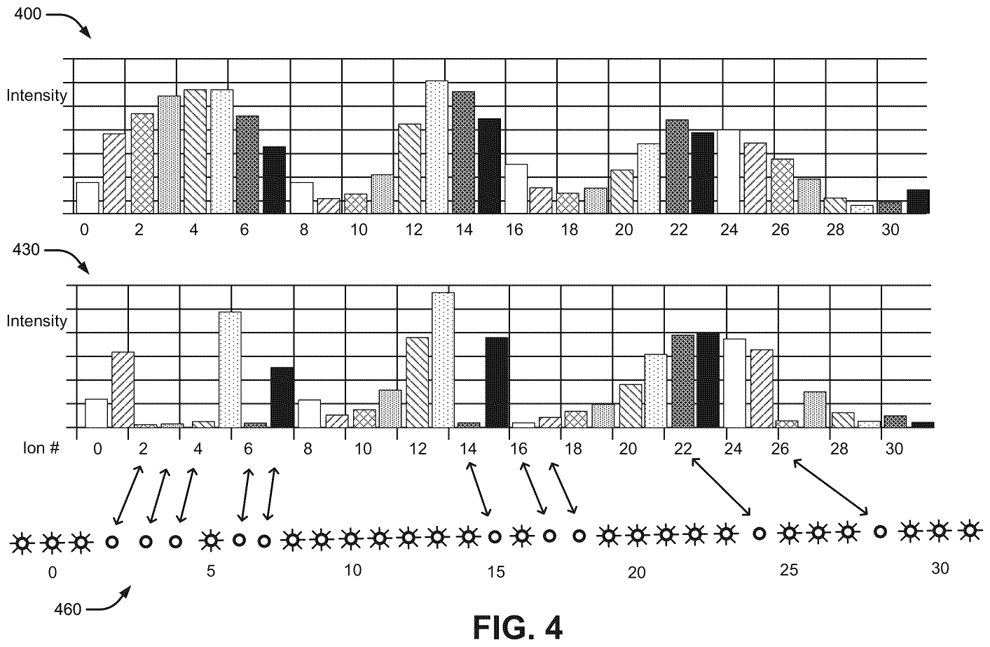

FIG. 4 illustrates a scheme for aligning the trapped ions according to aspects of the present disclosure. The scheme allows for the extraction of alignment information from every ion in the chain rather than from the ends of the ion chain. In some aspects, the scheme includes the follow steps:

1) Shelving a subset of the ions in the ion chain into the metastable dark state. Once shelved to the corresponding metastable dark state, the shelved ions in the ion chain may respond differently to optical excitation as compared to unshelved ions. In other words, if one or more optical beams impinge on a shelved ion and an unshelved ion, the two ions may exhibit different behaviors. For example, the shelved ion may not illuminate while the unshelved ion may illuminate. Other distinguishing behaviors may also be exhibited by the shelved and unshelved ions. The shelving process allows the shelved ions to be distinguishable from the non-shelved ions in the ion chain. Without the shelving process, all the ions in the ion chain may be indistinguishably bright or dark.

In an aspect of the present disclosure, the scheme may implement different methods to distinguish among ions. For example, the scheme may shelve a subset of the ions in the ion chain to different dark states different than the metastable dark state. Other schemes may also be implemented according to various aspects of the present disclosure.

2) Comparing the image of the ion chain as captured with a camera with the pattern of fluorescence captured by the detector array. The camera may reveal the pattern of bright/dark ions in the ion chain. The pattern may be compared to the pattern of the bright/dark ions detected by the detector array.

In some aspects of the present disclosure, the scheme above may begin with providing one or more light source, such as one or more lasers in the optical and trap controller 220, to the trapped ions of the ion chain to illuminate the trapped ions of the ion chain. Next, a camera, such as the camera in the imaging system 230, may capture one or more images of the trapped ions in the bright state. The positions of the ions may be recorded and/or marked to assign each trapped ion in the ion chain with an identifier. For example, the trapped ions may be numbered from 0 to 31. Other schemes for tracking the ions in the ion chain may also be used according to aspects of the present disclosure. Further, the ion chain may include a different number of ions.

Next, the scheme may apply the one or more light source (e.g., the one or more lasers in the optical and trap controller 220) to transition a subset of the trapped ions from the ground state to a dark metastable state. The duration for the transition may be much longer than the Rabi flopping time between the ground state and the dark metastable state. If other lasers are also applied during the shelving process that makes the remaining ions fluoresce when in the ground state, the ions may appear to randomly “blink” (toggling between the bright state and the dark state).

Next, the scheme may turn off the one or more light source (e.g., the one or more lasers in the optical and trap controller 220) that transitioned the subset of the trapped ions from the ground state to the dark metastable state. The shelved ions may stay in the dark metastable state for a duration that is typically comparable to or longer than the time needed to complete the current scheme before decaying back to the ground state. The scheme may turn on, or leave on, the lasers that make the remaining ions fluoresce when they are in the ground state. The ions will be randomly projected into either the ground state or the metastable state, which will imprint a random pattern of bright and dark ions in the ion chain.

Next, the scheme may include detecting the pattern of bright and dark ions via a camera, such as a camera in the imaging system 230. The detection may occur before the end of the lifetime of the ions in the metastable state (e.g., greater than or equal to 1 second and/or less than or equal to 10 seconds). Specifically, the detection may occur before the ions decay from the metastable state back to the ground state.

Next, the scheme may include comparing the patterns of bright and dark ions with the signals detected by one or more photodetectors, such as the one or more photodetectors of the imaging system 230, to align the ions with the one or more photodetectors.

In some aspects of the present disclosure, the scheme above may be repeated with a new random pattern.

In certain aspects of the present disclosure, within the aliasing pattern (if any), there may be stretches of several contiguous detectors that are properly aligned to the ions so that the mapping between the ions and the detectors can be determined. By observing how this mapping shifts through the aliasing pattern, both the sign of the magnification error and the direction of the ion chain must be shifted relative to the detectors can be determined.

In some aspects of the present disclosure, a particular pattern may be selected to reduce aliasing. The pattern may be selected based on the number of ions, system setup, ease of identification, low/no repetition within the pattern, and/or other factors according to aspects of the present disclosure.

In some aspects of the present disclosure, in FIG. 4, a first graph 400 shows the pattern of signals from the one or more photodetector array when all the ions are in the bright states. A second graph 430 shows the pattern of signals from the one or more photodetector after shelving (selective ions in the dark states). However, due to aliasing, misalignment, and/or other causes, one or more ions are not being properly detected by the photodetector array. An image 460 may show the captured image (by a camera) that show the bright ions ( [symbol] ) and the dark ions ( [symbol] ) shelved in the metastable states.

According to the second graph 430, ions 2-4, 6, 14, 16, 17, 26, and 29-31 appear to be dark. As such, based on the one or more photodetectors detection, these ions have been shelved to the metastable dark state.

However, according to the image 460, ions 2-4, 6, 7, 15, 17, 18, 24, and 28 are dark. Accordingly, there are discrepancies between the detection by the photodetector one or more, and the image 460 captured by the camera. Here, the image 460 is the accurate representation of the ions being shelved into the metastable states. The differences may be explained as follows.

Ion #7, which appears to be “bright” during the detection by the one or more photodetector, may have decayed out of the metastable dark state back to the ground bright state between the capture of the image 460 and the detection by the one or more photodetectors.

There are 6 bright ions (i.e., ions #8-13) between ions #7 and 14 according to the second graph 430, and 7 bright ions (i.e., ions #8-14) between ions #7 and 15 according to the image 460. The difference here may be caused by image aliasing in the photodetection. For example, there may be an extra ion between ions 9 and 10 that are not accounted for in the second graph 430.

There are 4 bright ions (i.e., ions #18-21) between ions #17 and 22 according the second graph 430, and 5 bright ions between ions #18 and 24 according to the image 460. The difference here may also be caused by image aliasing in the photodetection as described above.

Ion #22 (according to the second graph 430) or ion #24 (according to the image 460), which appears to be “bright” during the detection by the one or more photodetectors, may have fallen out of the metastable dark state back to the ground bright state between the capture of the image 460 and the detection by the one or more photodetectors similar to ion #7 above.

In the presence of a conflict between the detection by the one or more photodetectors and the image captured by the camera, the image may be used to adjust the alignment of the one or more photodetectors and the ion chain to reduce unwanted artifacts such as image aliasing, or other types of misalignment.

In alternative aspects of the present disclosure, the ions may be controlled individually and put into a deterministic pattern of bright and dark states (both spatially and temporally) rather than random shelving.

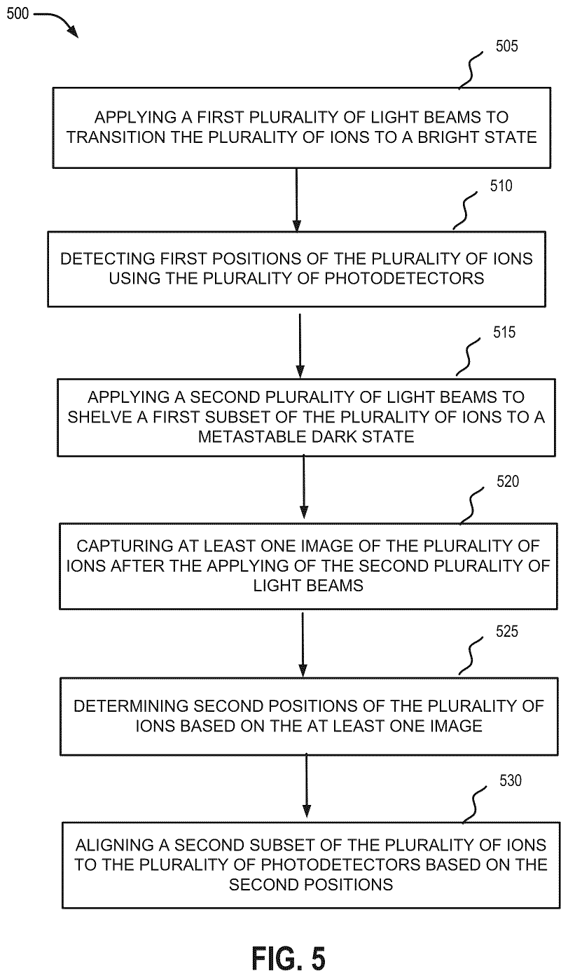

FIG. 5 illustrates an example of a method 500 of adjusting the misalignment between the one or more photodetectors and the ion chain according to aspects of the present disclosure. In general, it is noted that the method 500 may be performed by the general controller 205, the automation and calibration controller 280, the algorithm component 210, the optical and trap controller 220, the imaging system 230, the processor 310, the memory 320, and/or one or more subcomponents of the QIP system 200 or the computer device 300 according to various exemplary aspects as described above.

Initially, at 505, the method 500 may apply a first plurality of light beams to transition the plurality of ions to a bright state. For example, the general controller 205, the automation and calibration controller 280, the algorithm component 210, the optical and trap controller 220, the imaging system 230, the processor 310, the memory 320, and/or one or more subcomponents of the QIP system 200 or the computer device 300 may be configured to, and/or provide means for applying a first plurality of light beams to transition the plurality of ions to a bright state.

At 510, the method 500 may detect first positions of the plurality of ions using the plurality of photodetectors. For example, the general controller 205, the automation and calibration controller 280, the algorithm component 210, the optical and trap controller 220, the imaging system 230, the processor 310, the memory 320, and/or one or more subcomponents of the QIP system 200 or the computer device 300 may be configured to, and/or provide means for detecting first positions of the plurality of ions using the plurality of photodetectors.

At 515, the method 500 may apply a second plurality of light beams to shelve a first subset of the plurality of ions to a metastable dark state. For example, the general controller 205, the automation and calibration controller 280, the algorithm component 210, the optical and trap controller 220, the imaging system 230, the processor 310, the memory 320, and/or one or more subcomponents of the QIP system 200 or the computer device 300 may be configured to, and/or provide means for applying a second plurality of light beams to shelve a first subset of the plurality of ions to a metastable dark state.

At 520, the method 500 may capture at least one image of the plurality of ions after the applying of the second plurality of light beams. For example, the general controller 205, the automation and calibration controller 280, the algorithm component 210, the optical and trap controller 220, the imaging system 230, the processor 310, the memory 320, and/or one or more subcomponents of the QIP system 200 or the computer device 300 may be configured to, and/or provide means for capturing at least one image of the plurality of ions after the applying of the second plurality of light beams.

At 525, the method 500 may determine second positions of the plurality of ions based on the at least one image. For example, the general controller 205, the automation and calibration controller 280, the algorithm component 210, the optical and trap controller 220, the imaging system 230, the processor 310, the memory 320, and/or one or more subcomponents of the QIP system 200 or the computer device 300 may be configured to, and/or provide means for determining second positions of the plurality of ions based on the at least one image.

At 530, the method 500 may align a second subset of the plurality of ions to the plurality of photodetectors based on the second positions. For example, the general controller 205, the automation and calibration controller 280, the algorithm component 210, the optical and trap controller 220, the imaging system 230, the processor 310, the memory 320, and/or one or more subcomponents of the QIP system 200 or the computer device 300 may be configured to, and/or provide means for aligning a second subset of the plurality of ions to the plurality of photodetectors based on the second positions.

Aspects of the present disclosure may include methods and systems for detecting first positions of the plurality of ions using the plurality of photodetectors, applying a first plurality of light beams to transition the plurality of ions to a bright state, applying a second plurality of light beams to shelve a first subset of the plurality of ions to a metastable dark state, capturing at least one image of the plurality of ions after the applying of the second plurality of light beams, determining second positions of the plurality of ions based on the at least one image, and aligning a second subset of the plurality of ions to the plurality of photodetectors based on the second positions.

Aspects of the present disclosure include the method and/or system above, wherein the plurality of photodetectors includes one or more avalanche photodiodes, photo multipliers, and photon counters.

Aspects of the present disclosure include any of the method and/or system above, wherein capturing the at least one image of the plurality ions comprises capturing the at least one image of the plurality ions before the first subset of the plurality of ions transition out of the metastable dark state.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of aligning a plurality of ions of an ion chain to a plurality of photodetectors, comprising:
applying a first plurality of light beams to transition the plurality of ions to a bright state;
detecting first positions of the plurality of ions using the plurality of photodetectors;
applying a second plurality of light beams to shelve a first subset of the plurality of ions to a metastable dark state;
capturing at least one image of the plurality of ions after the applying of the second plurality of light beams;
determining second positions of the plurality of ions based on the at least one image; and
aligning a second subset of the plurality of ions to the plurality of photodetectors based on the second positions.

2. The method of claim 1, wherein the plurality of photodetectors includes one or more avalanche photodiodes, photo multipliers, and photon counters.

3. The method of claim 1, wherein capturing the at least one image of the plurality ions comprises capturing the at least one image of the plurality ions before the first subset of the plurality of ions transition out of the metastable dark state.

4. A quantum information processing (QIP) system, comprising:
one or more photodetectors configured to detect first positions of the plurality of ions;
a plurality of light sources configured to:
apply a first plurality of light beams to transition the plurality of ions to a bright state, and
apply a second plurality of light beams to shelve a first subset of the plurality of ions to a metastable dark state;
a camera configured to capture at least one image of the plurality of ions after the applying of the second plurality of light beams; and
a controller configured to:
determine second positions of the plurality of ions based on the at least one image; and
align a second subset of the plurality of ions to the plurality of photodetectors based on the second positions.

5. The QIP system of claim 4, wherein the plurality of photodetectors includes one or more avalanche photodiodes, photo multipliers, and photon counters.

6. The QIP system of claim 4, wherein the camera is further configured to capture the at least one image of the plurality ions before the first subset of the plurality of ions transition out of the metastable dark state.

7. A non-transitory computer readable medium having instructions that, when executed by one or more processors of a quantum information processing (QIP) system, cause the one or more processors to:
cause one or more photodetectors to detect first positions of the plurality of ions;
cause a plurality of light sources to:
apply a first plurality of light beams to transition the plurality of ions to a bright state, and
apply a second plurality of light beams to shelve a first subset of the plurality of ions to a metastable dark state;
cause a camera to capture at least one image of the plurality of ions after the applying of the second plurality of light beams; and
cause a controller to:
determine second positions of the plurality of ions based on the at least one image; and
align a second subset of the plurality of ions to the plurality of photodetectors based on the second positions.

8. The non-transitory computer readable medium of claim 7, wherein the plurality of photodetectors includes one or more avalanche photodiodes, photo multipliers, and photon counters.

9. The non-transitory computer readable medium of claim 7, wherein the instructions for causing the camera to capture the at least one image of the plurality ions comprises instructions for causing the camera to capture the at least one image of the plurality ions before the first subset of the plurality of ions transition out of the metastable dark state.
